(19) United States
(12) Patent Application Publication
(10) Pub. No.: US 2006/0051109 A1
(43) Pub. Date: Mar. 9, 2006

(54) Method and apparatus for manufacturing 3D image display

(76) Inventors: Jae-Ik Lim, Chuncheon-si (KR); Jae-Young Lee, Seoul (KR); Sang-Woo Kim, Suwon-si (KR); Poundaleva Irina, Suwon-si (KR); Sung-Eun Cha, Geoje-si (KR); Seung-Kyu Lee, Seongnam-si (KR); Jae-Hyun Kim, Suwon-si (KR); Hae-Young Yun, Suwon-si (KR); Kee-Han Uh, Yongin-si (KR); Won-Sang Park, Yongin-si (KR)

Correspondence Address: CANTOR COLBURN, LLP, 55 GRIFFIN ROAD SOUTH, BLOOMFIELD, CT, 06002, US

(21) Appl. No.: 11/223,588

(22) Filed: Sep. 9, 2005

(30) Foreign Application Priority Data
Sep. 9, 2004 (KR) 10-2004-0072220

(51) Int. Cl. G03G 15/00

(52) U.S. Cl. 399/22

(57) ABSTRACT

An adhesive is applied to a side of a 3D image forming device of a lenticular lens, parallax barrier, etc., and the 3D image forming device is adhered to an image panel. The image panel and the 3D image forming device are aligned whiling observing a 3D image of the adhered panel through a camera disposed thereabove. In this case, they are determined to be correctly aligned when a black stripe is positioned at the center of the image of the camera. Subsequently, the adhesive is hardened so as to fix the image panel and the 3D image forming device.

This application claims priority to Korean Patent Application No. 10-2004-0072220 filed on Sep. 9, 2004, and all of the benefits occurring therefrom under 35 U.S.C. 119, the entire contents of which are hereby incorporated by reference.

### BACKGROUND OF THE INVENTION

(a) Field of the Invention

The present invention relates to a method and apparatus for manufacturing a 3D image display.

(b) Description of the Related Art

Fast communication services based on the internet are expected to evolve from simpler services for hearing and speaking. Examples of such simple services that are expected to undergo an evolution as a result of the internet are telephone services, audible and visible multimedia services utilizing digital terminals. This evolution is expected to encompass processing characters, voices, and images rapidly. Such services are eventually expected to be developed to 3D communication services that enable realistic and stereoscopic viewing and hearing, overcoming temporal and spatial limitations.

Typically, a 3D image is observed because of the principle of stereo vision of two eyes. Binocular disparity (i.e., a disparity of two eyes caused because they are apart by a distance of about 65 mm) plays an important role in the observation of the stereoscopic effect. That is, when left and right eyes view different 2D images and the two images are transmitted to the brain through the retina, the brain combines the two images to reconstruct reality in the original 3D image. This reconstruction provides a depth perception of the observed object. Such ability is called stereography.

Schemes using the binocular disparity in 3D image displays are typically categorized as stereoscopic schemes or auto stereoscopic schemes. Examples of stereoscopic schemes are a polarization scheme and a time divisional scheme, while examples of auto stereoscopic schemes are a parallax barrier scheme and a lenticular scheme.

According to the stereoscopic schemes, a mass of people may simultaneously enjoy the 3D images, however polarization spectacles or liquid crystal shutter spectacles must be worn. On the other hand, according to the auto stereoscopic schemes, an image splitter, an array of cylindrical lenticular lenses, or a parallax barrier is combined with the display, thereby permitting only a small number of people to simultaneously view the 3D images. However, separate spectacles are not required for such an auto stereoscopic scheme. In other words, stereoscopic 3D image display requires wearing of special spectacles, thereby causing discomfort and artificiality to a viewer. However, according to the auto stereoscopic 3D image display, the viewer may enjoy the 3D images by simply watching the screen without the drawbacks of the stereoscopic 3D image display.

In an auto stereoscopic 3D image display, a 3D image forming device is aligned on an image panel to display a 3D image. The 3D image forming device is typically formed as a lenticular lens or a parallax barrier. The 3D image forming device may be combined with a converting device so as to be able to display 2D images as well as 3D images. For example, in WO 03015424A2 to Woodgate et al., a switching panel may be combined with a lenticular lens having refractive anisotropy to produce a 3D image forming device. In addition, a 3D image forming device for converting images between 3D and 2D may also be produced by combining a switching panel and a retarder or by combining a polarizer having slits and a switching panel.

As the basic structure for displaying a 3D image, a panel forming an image should be combined with a 3D image forming device for dividing the image into a left eye image and a right eye image. That is, in order to display a 3D image, one of two pixels should be assigned for the right eye image and the other of the two pixels should be assigned for the left eye image. Therefore, alignment of the image panel and the 3D image forming device is very important for proper display of the 3D image.

### SUMMARY OF THE INVENTION

The present invention provides a method and an apparatus for manufacturing a 3D image display enabling precise alignment of an image panel and a 3D image forming device.

An exemplary method for manufacturing a 3D image display according to an embodiment of the present invention includes aligning an image panel and the 3D image forming device using a black stripe displayed on the image panel. The image panel comprises a left eye image and a right eye image disposed next to each other with a black stripe in the middle.

Another exemplary method for manufacturing a 3D image display according to an embodiment of the present invention includes applying an adhesive to at least one side of at least one of an image panel and facilitating adhesion of the image panel with the 3D image forming device to form an adhered panel, aligning the image panel and the 3D image forming device while observing a displayed image of the adhered panel obtained under conditions for displaying a 3D image, and fixing the image panel and the 3D image forming device by hardening the adhesive. During the alignment of the image panel and the 3D image forming device, the image panel and the 3D image forming device are aligned such that a black stripe formed between a left eye image window and a right eye image window is positioned at a predetermined position.

In a further embodiment, the image panel is a liquid crystal panel, and the 3D image forming device is a lenticular lens array panel.

In a further embodiment, the 3D image forming device includes a lenticular lens array having a plurality of semi-cylindrical lenticular lenses continuously formed therein, and a polymer layer.

In a further embodiment, the image panel and the 3D image forming device are aligned such that the black stripe may be positioned at the center of the panel.

In a further embodiment, the image panel and the 3D image forming device are aligned while displaying different images as the left eye image and the right eye image to be formed by the adhered panel.

In a further embodiment, the image panel and the 3D image forming device are aligned while a white image is displayed as the left eye image and a black image is displayed as the right eye image.

In a further embodiment, a first alignment utilizing the position of the black stripe and second alignment utilizing positions of the white and black images are sequentially performed.

In a further embodiment, the adhesive is formed from a light-setting material, and the hardening of the adhesive is performed by irradiation of the light-setting material with light. The light is preferably ultraviolet light.

In another embodiment, an exemplary method for adhering a switching panel on the 3D image forming device is disclosed. An exemplary apparatus for manufacturing a 3D image display includes a main body, an image panel loader installed in the main body, a fine adjuster for adjusting a position of the image panel loader, a 3D image forming device loader installed in the main body for loading a 3D image forming device, a loader position adjuster for adjusting a position of the 3D image forming device loader, and a camera installed in the main body for observing an aligned state of the image panel and the 3D image forming device. In a further embodiment, the exemplary apparatus includes an adhesive applier installed in the main body for applying the adhesive on a bonding surface of the 3D image forming device.

In a further embodiment, the exemplary apparatus includes a UV ray irradiator for curing and hardening the adhesive. As noted above, the adhesive is used for adhering the image panel with the 3D image forming device.

In a further embodiment, the fine adjuster comprises an X-axis direction fine adjuster, a Y-axis direction fine adjuster, and a rotation fine adjuster.

In a further embodiment, the exemplary apparatus includes a rotation controller for controlling rotation of the 3D image forming device loader.

In a further embodiment, the exemplary apparatus includes a camera position controller for controlling a position of the camera.

In a further embodiment, the exemplary apparatus includes an adhesive applier position controller for controlling a position of the adhesive applier.

In a further embodiment, the exemplary apparatus includes a monitor for displaying an image obtained by the camera.

### BRIEF DESCRIPTION OF THE DRAWINGS

The above and other advantages of the present invention will become more apparent by describing exemplary embodiments thereof in detail with reference to the accompanying drawings, in which:

FIG. 1A to FIG. 1C are exemplary sectional views of 3D image displays according to the present invention;

FIG. 2 is a flowchart depicting an exemplary process for aligning the image panel and the 3D image forming device according to the present invention;

FIG. 3 is a flowchart depicting a detailed process for step S2 in FIG. 2;

FIG. 4 to FIG. 6 illustrates a principle for aligning an image panel and a 3D image forming device in a 3D image display according to an exemplary embodiment of the present invention; and

FIG. 7 depicts a perspective view of an exemplary apparatus for inspecting alignment of the image panel and the 3D image forming device and combining them in a method for manufacturing a 3D image display according to the present invention.

### DETAILED DESCRIPTION OF THE INVENTION

With reference to the accompanying drawings, the present invention will be described in order for those skilled in the art to be able to implement the invention. As those skilled in the art would realize, the described embodiments may be modified in various different ways, all without departing from the spirit or scope of the present invention.

To clarify multiple layers and regions, the thicknesses of the layers are enlarged in the drawings. Like reference numerals designate like elements throughout the specification. When it is said that any part, such as a layer, film, area, or plate is positioned on another part, it means the part is directly on the other part or above the other part with at least one intermediate part. In addition, if any part is said to be positioned directly on another part, it means that there is no intermediate part between the two parts.

Now, a method and an apparatus for manufacturing a 3D image display according to an exemplary embodiment of the present invention will be hereinafter described in detail with reference to the drawings.

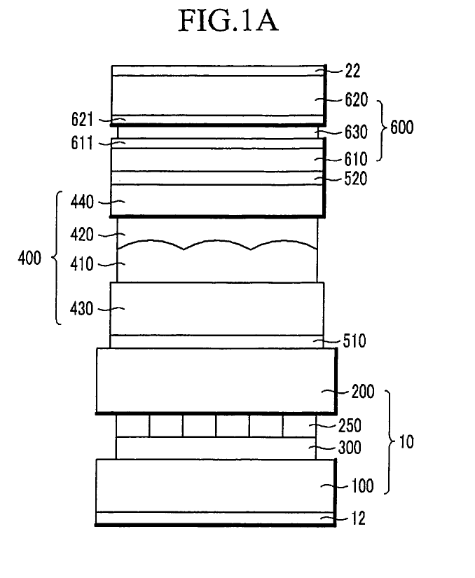

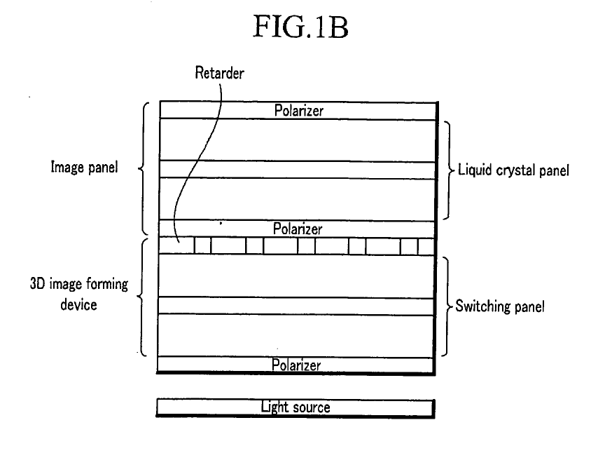

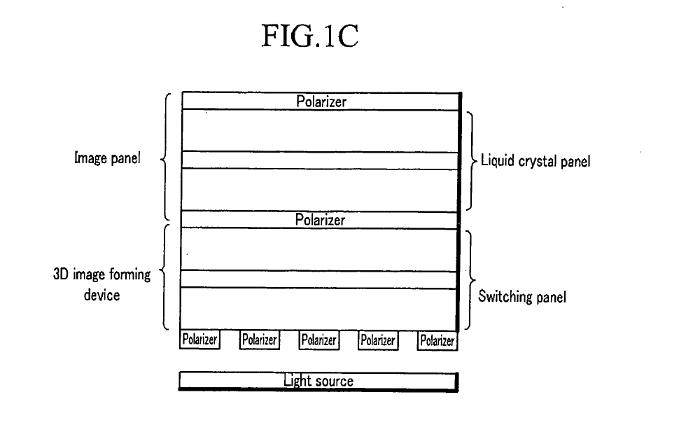

FIG. 1A to FIG. 1C are exemplary sectional views of 3D image displays manufactured according to an exemplary embodiment of the present invention.

Referring to FIG. 1A, a 3D image display device manufactured according to an exemplary embodiment of the present invention includes a liquid crystal panel 10 as an image panel, a lens panel 400 that acts as a 3D image forming device, a switching panel 600, and upper and lower polarizers 22 and 12. The liquid crystal panel 10 and the lens panel 400 are combined with an adhesive layer 510, and the lens panel 400 and the switching panel 600 are combined with another adhesive layer 520. The upper and lower polarizers 22 and 12 are respectively disposed above the switching panel 600 and below the liquid crystal panel 10, respectively.

The liquid crystal panel 10 includes a thin film transistor (TFT) array panel 100, a color filter array panel 200, and a liquid crystal layer 300.

The TFT array panel 100 includes signal lines such as gate lines (not shown) and data lines (not shown), and a TFT (not shown) and a pixel electrode (not shown) are formed at each pixel area. A pixel area is defined as an intersection point of the gate line and data line. The TFT switches are used to control signals to the pixel electrode. Accordingly the TFT switch can apply a scanning signal transmitted through the gate line and/or an image signal transmitted through the data line to the pixel electrode. The TFT switch can also cut off such signals from the pixel electrode.

The liquid crystal panel is usually categorized depending on arrangement of the pixel electrodes, as a backlit liquid crystal panel, a reflective liquid crystal panel, or a transflective type of liquid crystal panel, and a liquid crystal panel of any of the aforementioned types may be used as an image panel according to an exemplary embodiment of the present invention. However, for better understanding and ease of description, an exemplary embodiment will be described in detail in connection with a backlit liquid crystal panel in the following description.

The color filter array panel 200 and the TFT array panel 100 are separated by a predetermined distance but are disposed in such a manner so as to face each other. A color filter 250 is formed on the color filter array panel 200, and although not shown, a black matrix, a common electrode, or the like, is formed thereon.

A liquid crystal material is interposed between the TFT array panel 100 and the color filter array panel 200, and forms a liquid crystal layer 300.

The lens panel 400, also known as a “3D image forming device”, refracts light emitted from the liquid crystal panel 10 and distributes the light to left or right eyes in order to form a 3D image.

The lens panel 400 includes a lenticular lens array 410, a polymer 420 formed thereabove, and upper and lower substrates 440 and 430 respectively. A plurality of semi-cylindrical lenticular lenses extended in a row direction is continuously arranged in the lenticular lens array 410. In addition, the lenticular lens array 410 is attached to a lower substrate 430 and the polymer 420 is attached to an upper substrate 440.

Here, the lenticular lens array 410 has refractive anisotropy such that light having an electric field oscillating in a direction parallel to the lens axis is not refracted at a border thereof because refractive indices of the lens array 410 and the polymer 420 are effectively the same in that direction, and light having an electric field oscillating in a direction perpendicular to the lens axis is refracted at the border thereof because refractive indices of the lens array 410 and the polymer 420 are effectively different in that direction. Such a characteristic may be used to selectively display 2D or 3D images as desired.

In this case, the liquid crystal panel 10 is aligned with the lens panel 400 such that one semi-cylindrical lens of the lens panel 400 overlaps with at least two pixel arrays of the liquid crystal panel 10.

The switching panel 600 functions to select displaying a 2D image or displaying a 3D image. The switching panel 600 includes upper and lower substrates 610 and 620, upper and lower electrodes 611 and 621 respectively formed on the upper and lower substrates 610 and 620, and a liquid crystal layer 630 disposed therebetween.

Other details of structural features as well as the method of operation of the scheme shown in the drawing may be found in WO03015424, which is hereby incorporated by reference.

Hereinafter, another exemplary type of 3D image display manufactured according to an embodiment of the present invention will be described in detail.

Referring to FIG. 1B, an image panel and a 3D image forming device are combined. Positions of the image panel and the 3D image forming device may be interchanged relative to the light source. That is, the image panel may be disposed directly above the light source, and the 3D image forming device may be disposed between the image panel and the light source. The 3D image forming device combined with the image panel may form a 3D image or may convert a 3D image into a 2D image, or vice versa. The 3D image forming device includes a retarder and a switching panel, further details of which may be found in U.S. Pat. No. 6,046,849 to Moseley et al., U.S. Pat. No. 6,055,103 to Woodgate et al. or U.S. Pat. No. 6,437,915 to Moseley et al., all of which are hereby incorporated by reference. The image panel is the same as has been described in FIG. 1A.

Referring to FIG. 1C, an image panel and a 3D image forming device are combined into a single device i.e., 3D image display device. Positions of the image panel and the 3D image forming device may be interchanged relative to the light source. The 3D image forming device combined with the image panel may form a 3D image or may convert a 3D image to a 2D image, and vice versa. The 3D image forming device includes a polarizer having slits, and a switching panel, and further details thereof may be found in U.S. Pat. No. 4,717,949 to Eichenlaub or U.S. Pat. No. 6,157,424 to Eichenlaub, both of which are hereby incorporated by reference. The image panel is the same as has been described in connection with FIG. 1A.

A 3D image display of any type including an image panel and a 3D image forming device for dividing left eye and right eye images may be manufactured according to the present invention. Accordingly, a 3D image display of a lenticular lens array scheme, a parallax barrier scheme, or the like, may be manufactured according to an exemplary embodiment of the present invention.

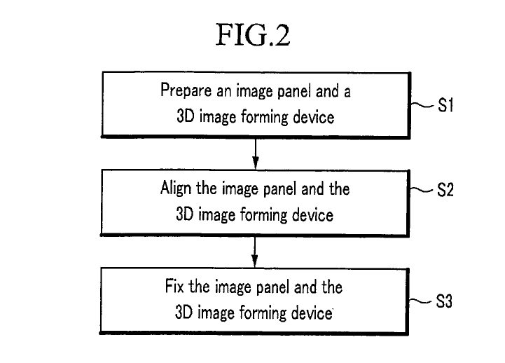

FIG. 2 is a flowchart showing a process for aligning the image panel and the 3D image forming device during a method for manufacturing a 3D image display.

At step S1, an image panel and a 3D image forming device is prepared. At step S2, the image panel and the 3D image forming device are aligned. At step S3, the alignment of the image panel and the 3D image forming device is completed.

The 3D image forming device corresponds to the image panel. The 3D image forming device is a device for dividing the image into an image for the left eye (a left eye image) and an image for the right eye (a right eye image). In order to divide the image into a left eye image and a right image, the 3D image forming device may function as a lenticular lens or a parallax barrier, a switching panel attached with the lenticular lens or the parallax barrier, or a panel including an addition film, a layer, and a sheet. In other words, the term “3D image forming device” is used to include any device that may divide an image into a left eye image and a right eye image when the viewer is desirous of viewing a 3D image.

Hereinafter, the aligning process shown in FIG. 2 is described in further detail in connection with the 3D image display shown in FIG. 1A. Firstly, at step S1, the liquid crystal panel 10 and the lens panel 400 are prepared. Then at step S2, the liquid crystal panel 10 and the lens panel 400 are attached to each other using the adhesive 510, and the liquid crystal panel 10 and the lens panel 400 are aligned so as to be able to form a 3D image. For example, they are aligned such that a predetermined number of pixels of the liquid crystal panel 10 may be positioned corresponding to each lens array of the lens panel 400. The predetermined number of pixels may be exemplarily set to be two (2) or four (4), and may have various other numbers according to design features of a 3D image display.

Then, the switching panel 600 is attached to the top of lens panel 400, and a polarizer, is further attached thereto. The lens panel 400 may be initially combined with the switching panel 600 such that they are aligned with and attached to the liquid crystal panel 10 afterwards.

In the above process, the lens panel 400 is used as the 3D image forming device. Depending on the case, the 3D image forming device may comprise a panel attached to the switching panel 600 and the lens panel 400.

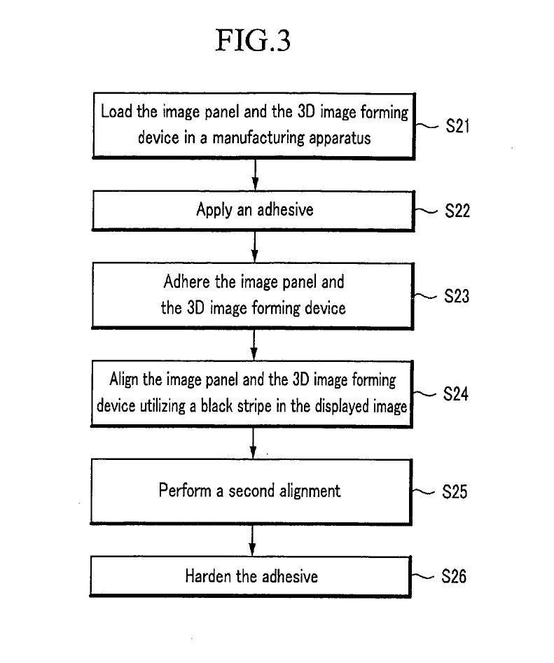

FIG. 3 is a flowchart showing a detailed process of the steps S2 and S3 in FIG. 2.

At step S21, the image panel and the 3D image forming device are loaded in a manufacturing apparatus.

Subsequently, at step S22, a light-setting material is applied to a side of at least one of the image panel and the 3D image forming device. The light setting material is converted into an adhesive upon irradiation with light. In one embodiment, the light setting material may be selected from the group consisting of an acrylic, an acrylate, a methacrylate, an epoxy, acrylate modified epoxies, or the like, that can be reacted and undergo curing upon interaction with ultraviolet light.

In one embodiment, these, adhesives are formed by polymerizing acrylic or methylacrylic acids through a reaction with a suitable catalyst. Acrylic adhesives and acrylate adhesives cure through a free radical mechanism. While they are usually supplied in a two-component form, they do not generally require mixing. The catalyst, accelerator, or hardener can be applied to one surface and the acrylic resin to the other surface. Sufficient diffusion will occur when the surfaces are joined to complete curing of the adhesive. Acrylic adhesives acrylate adhesives are available in both emulsion and solvent-based versions. Acrylate adhesives are used in construction applications. Many UV curable resins are acrylic base adhesives. Suitable examples of acrylate adhesives that may be used for bonding the image panel and the 3D image forming device are polyurethane dimethacrylates, polycarbonate dimethacrylates, ethoxylated bisphenol A dimethacrylate, or the like, or a combination comprising at least one of the foregoing acrylate adhesives. In another embodiment, pressure sensitive adhesives can also be used to promote adhesion between the image panel and the 3D image forming device. Pressure sensitive adhesives can be solvent based or melt based pressure sensitive adhesives. Examples of suitable pressure sensitive adhesives are phenolic resins amino resins (e.g., formaldehyde with urea or melamine), ethylene copolymers (e.g., ethylene-vinyl acetate), polyvinyl acetate, polyvinyl acetals, polyurethanes, epoxies, acrylics, polyamides, polyesters, polyimides, polybenzimidazoles, polyquinoxalines, or the like, or a combination comprising at least one of the foregoing pressure sensitive adhesives.

At step S23, the image panel and the 3D image forming device are bonded to each other to form the adhered panel.

Subsequently, at step S24, which represents the first alignment, the image panel and the 3D image forming device are aligned such that, while an image is displayed in the condition for displaying a 3D image on the adhered panel, a black stripe in the displayed image may be positioned at the center of the panel.

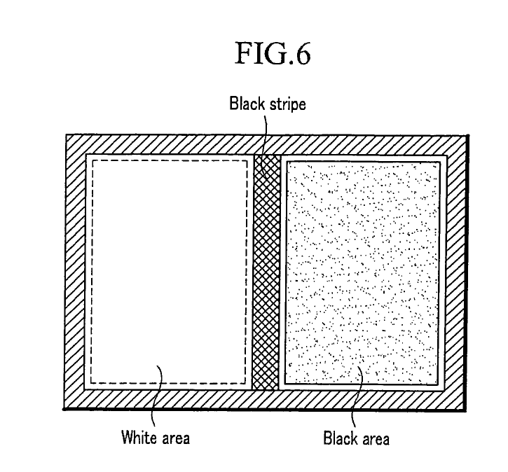

The adhered panel is then visually inspected while different image signals are applied to an odd-numbered pixel array and an even-numbered pixel array (e.g., displaying a white color at the odd-numbered pixel array and black color at the even-numbered pixel array) by applying power to a pin for visual inspection (VI). Then, different images are shown to the left and the right at the center of the black stripe. In the case that the white color is displayed at the odd-numbered pixel array and the black color is displayed at the even-numbered pixel array, a white area is displayed to one side of the black stripe and a black area is displayed to the other side thereof, as shown in FIG. 6.

Then at step S25, a second alignment is performed. When the white and black areas are located at predetermined positions, it is regarded that the second alignment is finished. When they are not located at the predetermined positions, relative positions of the image panel and the 3D image forming device are changed left and right until the white and black areas are positioned as predetermined.

Subsequently, at step S26, the adhesive is hardened to fix the panel by irradiating the adhesive with light. Thus the aligned panel is fixed in position after alignment.

At step S25, since the image displayed by the odd- and even-numbered arrays is obtained by driving the image panel and the 3D image forming device, a 3D image may not be displayed by the odd- and even-numbered arrays before precise alignment thereof. The image may be a monochrome image, a specific predetermined image, or a motion picture. In the case of the monochrome image, it may be a white image. Different monochrome images may be applied to the left eye image and the right eye image for the alignment, since an application of a monochrome image to a whole panel may cause an interchange of the left eye image and the right eye image.

For example, a black image may be used for the left eye image and a white image may be used for the right eye image. In this case, a black stripe is observed between the black and white images, and accordingly the adhered panel may be secondarily aligned with reference to the black stripe, the black image, and the white image.

The steps of S24 and S25 may be simultaneously performed.

Hereinafter, the process shown in FIG. 3 will be described in further detail in connection with the 3D image display shown in FIG. 1A.

At step S21, the liquid crystal panel 10 and the lens panel 400 are loaded in the manufacturing apparatus. Subsequently at step S22, an ultraviolet (UV) ray setting adhesive is applied to a side of the liquid crystal panel 10 or the lens panel 400. Then at step S23, the liquid crystal panel 10 and the lens panel 400 can be adhered or bonded to one another by their respective adhesion surfaces.

At step S24, the liquid crystal panel 10 and lens panel 400 are aligned such that the black stripe may be positioned at the center thereof.

For this procedure, while an image is displayed in the same condition for displaying a 3D image on the adhered liquid crystal panel 10 and the lens panel 400, the black stripe is observed by a camera disposed above the lens panel 400.

In this case, the lower polarizer 12 may be disposed below the liquid crystal panel 10. Alternatively, a separate polarizer functioning as the lower polarizer 12 may be provided to the manufacturing apparatus. In this case, the lower polarizer 12 may be attached after the alignment process.

Subsequently at step S26, after finishing the alignment, the adhesive 510 is hardened by irradiating the adhesive with light so as to fix the lens panel 400 to the liquid crystal panel 10.

Finally, a finished panel combined with the liquid crystal panel 10 and the lens panel 400 is unloaded from the manufacturing apparatus.

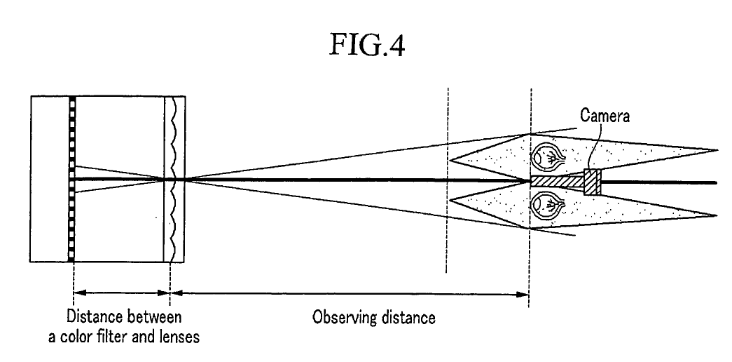

FIG. 4 to FIG. 6 illustrates a principle for aligning an image panel and a 3D image forming device in a 3D image display according to an exemplary embodiment of the present invention.

FIG. 4 illustrates a principle for displaying a black stripe at the center of the panel displaying the 3D image.

In a 3D image display utilizing the lenticular lens array, two adjacent pixel arrays correspond to one lens such that a light emitted from the two pixel arrays are refracted by the lens array so as to separately arrive at both eyes of a viewer. Due to such separate arrival of light, binocular disparity is caused at the eyes of a viewer thereby enabling the viewer to perceive the stereoscopic effect.

As shown in FIG. 4, the light emitted from the two pixel arrays are refracted at the lens such that the light from one pixel array may be directed to the right eye and that from the other pixel array may be directed to the left eye. Accordingly, no light is directed between the two eyes. Therefore a black stripe is seen at the center of the 3D image. When the lens and the two pixel arrays are aligned, the black stripe vertically appears at the center of the panel to the eyes of a viewer who observes the panel at a predetermined viewing distance (or a predetermined focal distance) from the center of the panel.

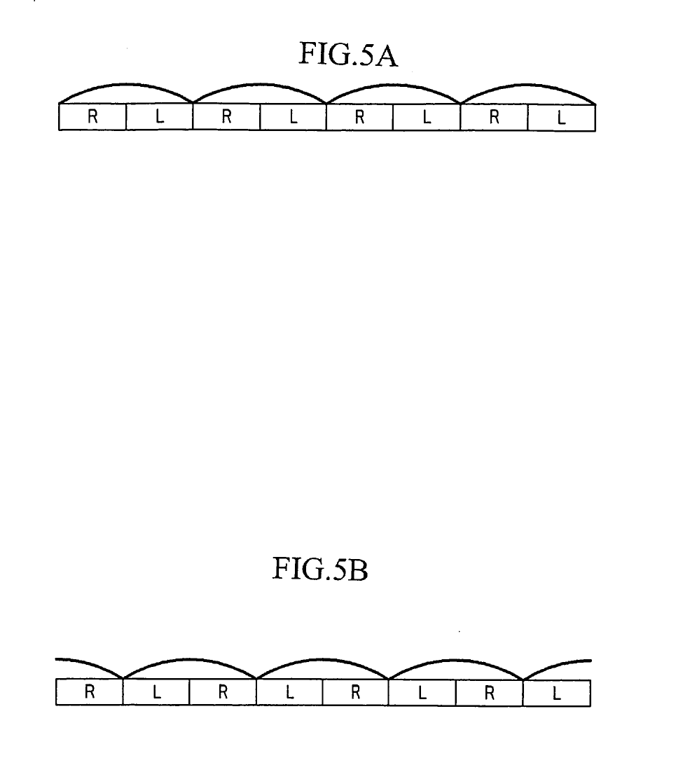

FIGS. 5A and 5B illustrate the interchange of the left eye image and the right eye image.

While aligning according to the principle illustrated in the FIG. 4, the left eye image and the right eye image may be interchanged in some cases. In particular, a monochrome image is used for the 3D image, and the left eye image and the right eye image may possibly be interchanged because they are the same. That is, the liquid crystal panel and the lens array may be aligned in two ways, as shown in FIG. 5A or as shown in FIG. 5B. In these two cases, the alignment of FIG. 5A will produce a normal 3D image. However, the alignment of FIG. 5B will produce a 3D image wherein the left eye image and right eye image can be reversed. Therefore, the panels should be aligned as shown in FIG. 5A.

FIG. 6 illustrates a principle for alignment that prevents the interchange of the left eye image and the right eye image. During the alignment, the interchange of the left eye image and the right eye image may be prevented by displaying different images on portions corresponding to the left eye image and the right eye image. For example, a first image of a white color may be displayed on the portion corresponding to the left eye image, and a second image of a black color may be displayed on the portion corresponding to the right eye image.

The left eye image and the right eye image may be observed by a camera. All of the first image, the second image, and the black stripe may be observed through the camera about the center of the panel, since binocular disparity is not incurred by a camera. In this case, the camera may be separated from the panel by a viewing distance (or a focal length) of the 3D image display. The viewing distance may depend on design features of the panel, and an exemplary value thereof may be about 20 centimeters to about −60 centimeters perpendicular from the panel. Depending on the case, the image may be observed while moving the camera.

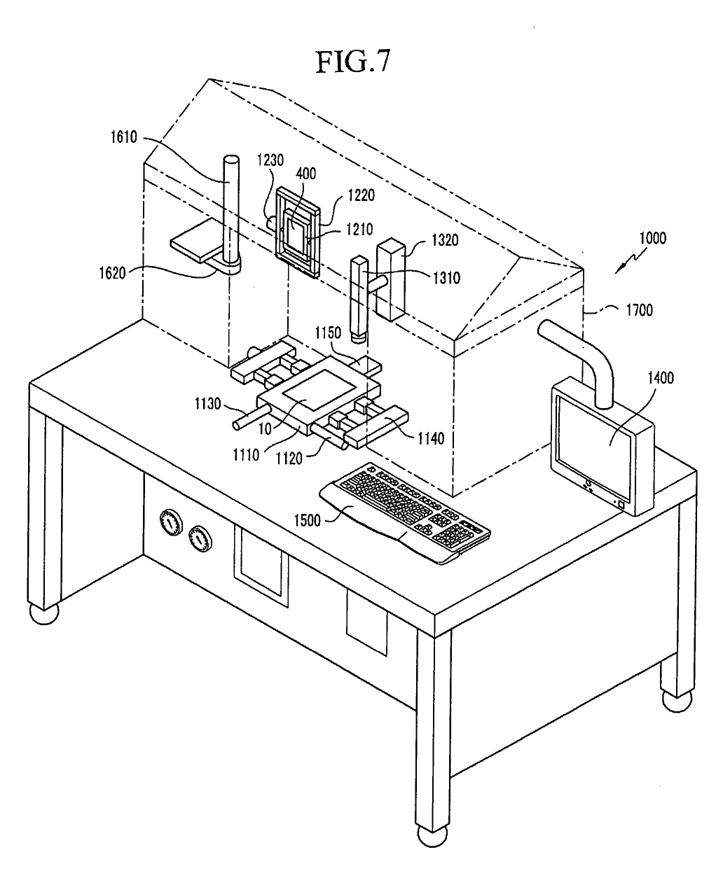

FIG. 7 shows an apparatus for manufacturing a 3D image display according to an embodiment of the present invention, and more particularly, shows a perspective view of an apparatus for inspecting alignment of the image panel and the 3D image forming device and combining them in a method for manufacturing a 3D image display according to an exemplary embodiment of the present invention.

A manufacturing apparatus 1000 of a 3D image display includes an image panel loader 1110, an X-axis fine adjuster 1120 for moving the image panel loader 1110 in the X-axis direction, a Y-axis fine adjuster 1130 for moving the image panel loader 1110 in the Y-axis direction, a UV ray irradiator 1140 for hardening the adhesive, and a rotation fine adjuster 1150 for rotating the image panel loader 1110.

The manufacturing apparatus 1000 further includes a 3D image forming device loader 1210, a rotation controller 1230 for rotating the 3D image forming device loader 1210, and a loader position controller 1220 for moving the 3D image forming device loader 1210 vertically and horizontally.

The manufacturing apparatus 1000 further includes a camera 1310 and a camera position controller 1320 for moving the camera 1310.

The manufacturing apparatus 1000 further includes an adhesive applier 1610 and an adhesive applier position controller 1620 for moving the adhesive applier 1610.

In addition, the manufacturing apparatus 1000 further includes an input section 1500 including a start button and a keyboard, a monitor 1400, and a main body 1700 mounted therewith.

An operation of the manufacturing apparatus 1000 is described in detail in connection with a process of manufacturing the 3D image display shown in FIG. 1A.

When the liquid crystal panel 10 and the lens panel 400 are respectively loaded to the image panel loader 1110 and the 3D image forming device loader 1210, the adhesive applier 1610 moves to a position above the lens panel 400 by operating the adhesive applier controller 1620 and applies an adhesive thereon. In this case, the 3D image forming device loader 1210 may also moved by the rotation controller 1230 and the loader position controller 1220.

Subsequently, the 3D image forming device loader 1210 rotates the lens panel 400 by the operation of the rotation controller 1230 such that a surface thereof applied with the adhesive faces downward, and moves the lens panel 400 by the operation of the loader position controller 1220 such that the lens panel closely faces the image panel 10 at their combining surfaces.

In this state, X-axis, Y-axis, and rotation fine adjusters 1120, 1130, and 1150 are controlled to perform first and second alignments, while observing an image of the camera 1310 through the monitor 1400. In this case, the camera position controller 1220 may be operated to adjust the position of the camera 1310.

After the alignments, the adhesive is hardened by irradiating with ultraviolet light by the UV ray irradiator 1140, and accordingly, the liquid crystal panel 10 and the lens panel 400 are fixedly combined.

According to a method and an apparatus according to an exemplary embodiment of the present invention, an image panel and a 3D image forming device may be aligned efficiently when manufacturing a 3D image display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for manufacturing a 3D image display, comprising:
applying an adhesive to a side of at least one of an image panel and a 3D image forming device;
combining the image panel and the 3D image forming device to each other to form an adhered panel;
aligning the image panel and the 3D image forming device while observing a displayed image of the adhered panel obtained under a condition for displaying a 3D image; and
fixing the image panel and the 3D image forming device by hardening the adhesive, wherein, during the aligning of the image panel and the 3D image forming device, the image panel and the 3D image forming device are aligned such that a black stripe formed between a left eye image window and a right eye image window is positioned at a predetermined position.

2. The method of claim 1, wherein the image panel is a liquid crystal panel, and the 3D image forming device is a lenticular lens array panel.

3. The method of claim 2, wherein the 3D image forming device comprises a: lenticular lens array having a plurality of semi-cylindrical lenticular lenses continuously formed therein; and polymer layer.

4. The method of claim 1, wherein the image panel and the 3D image forming device are aligned such that the black stripe may be positioned at a horizontal center of the panel.

5. The method of claim 4, wherein the image panel and the 3D image forming device are aligned while displaying different images as the left eye image and the right eye image to be formed by the adhered panel.

6. The method of claim 5, wherein the image panel and the 3D image forming device are aligned, while a white image is displayed as the left eye image, and a black image is displayed as the right eye image.

7. The method of claim 6, wherein a first alignment utilizing the position of the black stripe and a second alignment utilizing positions of the white and black images are sequentially performed.

8. The method of claim 1, wherein the adhesive is formed from a light-setting material, and wherein the light setting material is converted into an adhesive by irradiation with light.

9. The method of claim 1, wherein the light is ultraviolet light.

10. The method of claim 1, wherein the light setting material is a thermoset.

11. The method of claim 1, wherein the light setting material is selected from the group consisting of an acrylic, an acrylate, a methacrylate, an epoxy, acrylate modified epoxies, or a combination comprising at least one of the foregoing light setting materials.

12. The method of claim 1, wherein the adhesive is a pressure sensitive adhesive.

13. The method of claim 1, further comprising adhering a switching panel on the 3D image forming device.

14. An apparatus for manufacturing a 3D image display, comprising:
a main body;
an image panel loader installed in the main body;
a fine adjuster that adjusts a position of the image panel loader;
a 3D image forming device loader installed in the main body and loading a 3D image forming device;
a loader position adjuster that adjusts a position of the 3D image forming device loader; and
a camera installed in the main body that observes an aligned state of the image panel and the 3D image forming device.

15. The apparatus of claim 14, further comprising an adhesive applier installed in the main body and applying the adhesive on a bonding surface of the 3D image forming device.

16. The apparatus of claim 14, further comprising a UV ray irradiator that irradiates the adhesive for adhering the image panel and the 3D image forming device.

17. The apparatus of claim 14, wherein the fine adjuster comprises an X-axis direction fine adjuster, a Y-axis direction fine adjuster, and a rotation fine adjuster.

18. The apparatus of claim 14, further comprising a rotation controller that controls rotation of the 3D image forming device loader.

19. The apparatus of claim 14, further comprising a camera position controller that controls a position of the camera.

20. The apparatus of claim 14, further comprising an adhesive applier position controller that controls a position of the adhesive applier.

21. The apparatus of claim 14, further comprising a monitor that displays an image obtained by the camera.

22. A method for manufacturing a 3D image display, comprising:
displaying a left eye image and a right eye image on an adhered panel of an image panel and a 3D image forming device; and
aligning the image panel and the 3D image forming device using a black stripe displayed on the adhered panel.

23. The method of claim 22, further comprising, after the aligning of the image panel and the 3D image forming device, fixing the image panel and the 3D image forming device.
